(19) United States
(12) Patent Application Publication
(10) Pub. No.: US 2005/0216620 A1
(43) Pub. Date: Sep. 29, 2005

(54) KVM and USB peripheral switch

(76) Inventors: Francisc Sandulescu, Bucurest (RO); Adrian Bica, Solon, OH (US); Justin Thomas Gierke, Lakewood, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/811,162

(22) Filed: Mar. 26, 2004

(51) Int. Cl. G06F 13/14

(52) U.S. Cl. 710/62

(57) ABSTRACT

The present invention relates to a system and method for switching KVM and peripheral interfaces between host interfaces. Provided is a KVM switch where a keyboard and a mouse are emulated at host interfaces of the KVM switch and hosts are emulated at keyboard and mouse interfaces of the KVM switch. In addition, the KVM switch provided is capable of switching, either independently or concurrently with a keyboard and mouse, additional peripherals, such as USB peripherals.

### FIELD OF THE INVENTION

The present invention relates to communication with peripheral devices and, more specifically, to a system and method for switching keyboard, video, mouse, and additional USB connections among hosts.

### BACKGROUND OF THE INVENTION

USB is a peripheral bus standard developed by the PC and telecom industry, including Compaq, DBC, IBM, Intel, Microsoft, NEC and Northern Telecom. USB defines a bus and protocols for the connection of computer peripherals to computers (and computers to each other). “Universal Serial Bus Specification,” Compaq, Intel, Microsoft, NEC, Revision 1.1, Sep. 23, 1998, describes USB and its implementation and is incorporated herein by reference. In addition to standard USB devices and technologies, a new USB standard 2.x now exists. “Universal Serial Bus Specification,” Compaq, Hewlett-Packard, Intel, Lucent, Microsoft, NEC, Philips, Revision 2.0, Apr. 27, 2000 describes the most current USB 2.x standard and its implementation and is incorporated herein by reference. The USB 2.x standard permits faster data transmission than the USB 1.x standard.

Proposed and actual USB devices include keyboards, mice, telephones, digital cameras, modems, digital joysticks, CD-ROM drives, tape and floppy drives, digital scanners, printers, MPEG-2 video-base products, data digitizers, and other devices. USB protocol supports the dynamic insertion and removal of such devices from the bus (or “hot-plugging”) and recognizes actual peripherals or “functions”; hosts (typically a computer); and hubs, which are intermediate nodes in the network that allow the attachment of multiple downstream hubs or functions. Upon insertion of an downstream hub or function, the host/hub on the upstream side of the bus initiates a bus enumeration to identify and configure the new device. Upon removal, the removed device is “forgotten.”

A keyboard, video, mouse switch (KVM switch) is designed to connect a keyboard, video display monitor, and mouse to input ports (keyboard and mouse) and output ports (video) of computers. KVM switches allow KVM devices to be switched among any of a number of computers. When switching keyboard and mouse devices between hosts, it may be desirable for it to appear to the host that the keyboard and mouse always are connected, even when they have been “switched” to another host. This “permanent connection” enables auto-boot functionality and translation.

As computer peripherals, and particularly USB peripherals, become increasingly more popular, the need to switch peripheral devices, as well as keyboard and mouse devices, becomes more pressing. Therefore, it may be desirable for a KVM switch to be capable of switching, either concurrently or independently, keyboard and mouse devices and peripheral devices.

### BRIEF SUMMARY OF THE INVENTION

According to the present invention, there is provided a KVM and USB peripheral switch comprising: a plurality of sets of KVM interfaces, each set of KVM interfaces having a keyboard interface, a mouse interface, and a video interface; a plurality of sets of host interfaces, each set of host interfaces having a host keyboard and mouse interface and a host video interface; at least one USB peripheral interface; at least one host USB peripheral interface; and a master controller configured to switch at least one of the sets of KVM interfaces and at least one of the USB peripheral interfaces between the host interfaces; wherein a keyboard and mouse host is emulated to the keyboard interface and the mouse interface; and wherein a keyboard and a mouse is emulated to the host interface.

Also according to the present invention, there is provided a KVM and peripheral switch comprising: a plurality of sets of KVM interfaces, each set of KVM interfaces having a keyboard interface, a mouse interface, and a video interface; at least one user controller communicably coupled to at least one of the sets of KVM interfaces, the user controller being configured to emulate a keyboard and mouse host; and a plurality of sets of host interfaces, each set of host interfaces having a host keyboard and mouse interface and a host video interface; at least one computer controller communicably coupled to at least one of the sets of host interfaces, the computer controller being configured to emulate a keyboard and a mouse; at least one USB peripheral interface; at least one host USB peripheral interface; and a peripheral switch communicably coupled to at least one of the peripheral interfaces and to at least one of the host peripheral interfaces and configured to switch the USB peripheral interfaces between the host peripheral interfaces; and a video switch communicably coupled to at least one video interface and to at least one host video interface and configured to switch the video interfaces between the host video interfaces; and a master controller communicably coupled to the user controller, the computer controller, the peripheral switch, and the video switch and configured to switch at least one of the sets of keyboard, mouse and video interfaces and at least one of the USB peripheral interfaces between the host interfaces.

Also according to the present invention, there is provided a method for switching at least one keyboard interface, at least one mouse interface, at least one video interface, and at least one peripheral interface between host interfaces comprising: emulating a keyboard and a mouse to each host interface; emulating a host to each keyboard interface and mouse interface; receiving a switching command at a controller, the switching command containing identification information; and using the identification information to connect at least one of the keyboard interfaces, at least one of the mouse interfaces, at least one of the video interfaces, and at least one of the peripheral interfaces to at least one of the host interfaces.

### BRIEF DESCRIPTION OF THE DRAWINGS

FIG. 1A is a block diagram of a system with a KVM and peripheral switch;

FIG. 1B is a block diagram of a system with a KVM and peripheral switch using a universal interface for keyboard and mouse devices;

FIG. 2 is a block diagram of a universal keyboard and mouse interface;

FIG. 3 is a block diagram of a universal computer interface; and

FIG. 4 is a flow chart generally illustrating an aspect of switching keyboard and mouse devices with peripheral devices.

### DETAILED DESCRIPTION OF THE INVENTION

The present invention relates to a system and method for switching KVM and peripheral interfaces between host interfaces. Provided is a KVM switch where a keyboard and a mouse are emulated to host interfaces of the KVM switch and hosts are emulated to keyboard and mouse interfaces of the KVM switch. In addition, the KVM switch provided is capable of switching, either independently or concurrently with a keyboard and mouse, additional peripherals, such as USB peripherals.

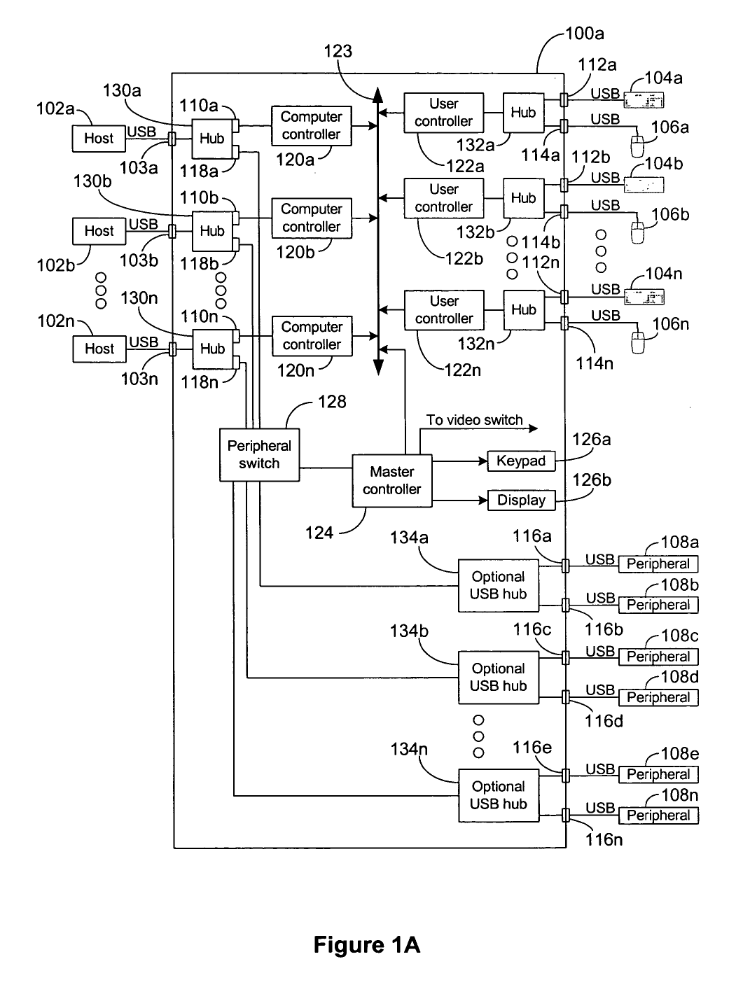

Turning initially to FIG. 1A, a block diagram of a system with a USB KVM and peripheral switch is illustrated. Each set of KVM interfaces includes a keyboard interface, a mouse interface, and a video interface and each set of host interfaces includes a host keyboard and mouse interface and a host video interface. For the purpose of the present invention the video switch can be any video switch. Accordingly, only the keyboard, mouse, and peripheral switching capabilities are detailed herein. It will be understood by those skilled in the art that a video data path (not shown) includes a host video interface communicably coupled to the video source and a video interface communicably coupled to a video output device, such as a monitor or the like. Further, it will be understood that the KVM and peripheral switch includes a video switch, communicably coupled to the video data path, configured to switch the video interfaces between the host video interfaces. The video data can be switched either concurrently or independently with the keyboard, mouse, and/or peripheral data through the use of technology known in the art. Any video switching technology known in the art may be used.

The KVM and peripheral switch 100a is generally positioned between and connectable to at least two USB hosts 102x and at least two sets of USB user input devices, each set including a keyboard 104x and mouse 106x. The KVM and peripheral switch 100a may be compatible with USB 1.x, USB 2.x, or both. The hosts 102x may be any USB hosts and are connectable to the switch 100a via respective hub interfaces 103x. Because the switch 100a is designed to be capable of switching both USB peripherals and USB keyboard and mouse devices to a USB host, a USB hub 130x is used so that a single USB host 102x is communicably coupled to both a keyboard and mouse data path and to a peripheral data path.

Referring first to the keyboard and mouse data path, each host keyboard and mouse interface 110x of a corresponding hub 130x is communicably coupled to a computer controller 120x. The computer controller emulates a keyboard and mouse, such as keyboard 104x and mouse 106x, to the host keyboard and mouse interface 110x. Therefore, to the USB host 102x, the computer controller 120x appears as a USB keyboard and mouse.

Each keyboard 104x is connected to switch 100a via a respective keyboard interface 112x and each mouse 106x is connected to the switch 100a via a respective mouse interface 114x. Both the keyboard interface 112x and the mouse interface 114x are communicably coupled to a user controller 122x via a USB hub 132x.

The computer controller 120x is communicably coupled to a bus 123. The bus 123 may be any communication bus, such as an I²C bus or the like. Also coupled to the bus 123 is each user controller 122x. Each user controller 122x is in turn communicably coupled to a keyboard interface 112x and a mouse interface 114x via a USB hub 132x. In addition, the computer controller 120x and the user controller 122x may be implemented as a single controller.

As shown, each computer controller 120x interacts with a host keyboard and mouse interface 110x. Those skilled in the art will understand that various configurations may be used, such as utilizing a computer controller 120x capable of interacting with multiple host keyboard and mouse interfaces 110x and emulating multiple keyboard and mouse combinations. Similarly, each user controller 122x interacts with a keyboard interface 112x and a and mouse interface 114x via a hub 132. Those skilled in the art will understand that various configurations may be used, such as utilizing a user controller 122x capable of interacting with multiple keyboard interfaces 112x and mouse interfaces 114x and emulating a host to each of the keyboard interfaces 112x and mouse interfaces 114x.

A master controller 124 is also communicably coupled to the bus 123. Thus, the master controller 124 is communicably coupled to each computer controller 120x and to each user controller 122x. Each of the computer controllers 120x, the user controllers 122x, and the master controller 124 may be a control circuit implemented as one or combinations of the following: programmable circuit, integrated circuit, memory and i/o circuits, an application specific integrated circuit, microcontroller, complex programmable logic device, field programmable gate arrays, other programmable circuits, or the like.

Referring next to the video data path, a monitor(s), display(s) or the like is connectable to the switch 100a via a video interface (not shown). Likewise, a video host(s) is connectable to the switch 100a via a video host interface (not shown). The video data that is switched may include Display Data Channel (DDC) data, which is a standard created by the Video Electronics Standard Association (VESA) that allows control through software of the settings of a graphical terminal, such as a monitor. Using DDC standard, a monitor can directly communicate with a video source. A graphical adapter can receive from the monitor all the information about its features and consequently, a graphical adapter is capable of automatic configuration for optimized refresh values depending on the resolution one uses.

Communicably coupled to the video interface and video host interface is a video switch (not shown), which is in turn communicably coupled to the master controller 124. Thus, the master controller 124 may be configured to control the video switch and the switching of the keyboard interfaces 112x and mouse interfaces 114x. The video interface may be switched either concurrently with, or independent of, the keyboard interface 112x and mouse interface 114x.

Referring next to the USB peripheral data path, at least one USB peripheral 108x is connectable to the switch 100a via a respective peripheral interface 116x. Communicably coupled to the peripheral interface 116x is a peripheral switch 128. Optionally, a USB hub 134x may be utilized to increase the number of peripheral interfaces 116x connectable to the peripheral switch 128. The peripheral switch 128 may be, for example, a dual analog crosspoint matrix switch, bus switch, router, or any other signal routing mechanism known in the art. The peripheral switch 128 may be a control circuit implemented as one or combinations of the following: programmable circuit, integrated circuit, memory and i/o circuits, an application specific integrated circuit, microcontroller, complex programmable logic device, field programmable gate arrays, other programmable circuits, or the like.

Each of the hubs 130x is communicably coupled to the peripheral switch 128 via the host peripheral interface 118x. The hub 130x is in turn communicably coupled to the host 102x via the hub interface 103x.

The master controller 124 is also communicably coupled to the peripheral switch 128 and to at least one user interface 126x, labeled as keypad and display. The user interfaces 126x may be any interface for communicating with the master controller 124, such as one or more of: buttons, LEDs, RS232 commands, Ethernet, one or more remote toggle switch, on-screen display, LCD, and the like.

Having generally described the present invention, various aspects of an embodiment of the invention is described in further detail. The computer controller 120x communicates with the host 102x and is configured to receive USB messages from the host 102x. The computer controller 120x is further configured to convert the received messages from USB to I²C and send the messages to a user controller 122x via the bus 123. The computer controller 120x is also configured to receive messages from a user controller 122x via the bus 123, convert the messages from I²C to USB, and send the converted messages to the host 102x. Because the computer controller 120x is capable of emulation, the computer controller 120x appears to the host 102x as a USB keyboard, such as a keyboard 104x, and a USB mouse, such as a mouse 106x.

The user controller 122x communicates with the keyboard 104x and the mouse 106x. The user controller 122x is configured to receive messages and commands in the form of I²C data from the computer controller 120x via the bus 123, convert the received data from I²C to USB data, and send USB data to the keyboard 104x and the mouse 106x. The user controller 122x is also configured to receive USB data from the keyboard 104x and mouse 106x, convert the received data from USB to I²C data, and transmit the converted I²C data to the computer controller 120x via the bus 123. Because the user controller 122x is capable of emulation, the user controller 122x appears to the keyboard 104x and the mouse 106x as a USB host, such as a host 102x.

The master controller 124 controls switching. The master controller 124 is configured to interpret switching commands received from the appropriate user interface 126x, convert the received commands to I²C data, and communicate to the computer controller 120x and the user controller 122x via the bus 123. The switching commands received from the user interface may contain identification information. Such identification information may include, for example, a user identification number corresponding to the user requesting the switch and a computer identification number corresponding to the computer to which the user wishes to connect.

The user identification information may inform the master controller 124 which user controller 122x to instruct to communicate. Similarly, the computer identification information may inform the master controller 124 which computer controller 120x to instruct to communicate. Thus, based on the computer information and/or user information, the master controller 124 may instruct, for example, the computer controller 120a to communicate with the user controller 122c.

The master controller thus communicates via the bus 123, using a communication protocol such as I²C, with the appropriate computer controller 120x and user controller 122x and directs them to communicate USB data to each other. It will be understood by those skilled in the art that it is possible to have multiple user controllers 122x connected to the same computer controller 120x. In such configurations, the computer controller 120x may implement a “priority receive” and communicate with the first user controller 122x to begin communications—all others will be ignored until a time-out period has passed in which there have been no communications from any of the user controllers 122x.

The master controller 124 may also be configured to implement security features. The master controller 124 may allow and disallow certain user controller 122x and computer controller 120x connections based on permissions. If the master controller 124 receives a request for a connection that is not allowed, the master controller 124 may deny the connection request and respond back to the user interface 126x that the connection cannot be made. Further, connections also may be password and/or biometric data protected. Upon receiving a request for a connection that is password protected, the master controller 124 may request that the appropriate password be entered. Once the correct password has been received and authenticated, the master controller 124 will transmit the commands to the appropriate user controller 122x and computer controller 120x. If authentication fails, the master controller 124 may deny the request or offer another chance to re-enter the correct password.

In addition to switching the keyboard interface 112x and mouse interface 114x among host interfaces, it is also possible to switch additional peripheral interfaces 116x among host interfaces. Additional peripherals 108x may include devices such as printers, scanners, cameras, memories (e.g., disk drives), writing tablets, or any other non-keyboard, non-mouse USB device.

To accomplish the peripheral switching, a USB hub 130x having at least two downstream ports is connected to the host 102x. One downstream port is connected to the computer controller 120x via the host keyboard and mouse interface 110x. The other downstream port is connected to a peripheral switch 128, such as dual analog crosspoint matrix switch, via the host peripheral interface 118x. The peripheral switch 128 routes peripheral USB signals (D+ and D−) to host USB signals. The peripheral switch 128 can connect directly to a USB connector for a USB peripheral, or can connect to another USB hub, such as optional USB hub 134x, allowing multiple USB peripherals to be connected.

The peripheral switch 128 is communicably coupled to the master controller 124. In this configuration, master controller 124 can be configured to permit the peripheral interfaces 116x to be switched concurrently with the keyboard interface 112x and mouse interface 114x, or independently. To concurrently switch the peripheral interface 116x with the keyboard interface 112x and mouse interface 114x, the master controller 124 receives switching commands from a user interface 126x and transmits them to both the appropriate computer controller 120x and user controller 122x and to the peripheral switch 128. These commands intended for the peripheral switch can be transmitted via I²C or another serial data protocol, or via a parallel address/data scheme. In this manner, all USB devices (keyboard, mouse, plus extra USB devices) are switched from computer to computer.

To switch the peripheral interface 116x independently, the master controller 124 receives switching commands from the user interface 126x and determines whether the commands are intended to switch keyboard interfaces 112x and mouse interfaces 114x, peripheral interfaces 116x, or both. Upon making its determination, the master controller 124 transmits the appropriate commands to the peripheral switch 128. Again, these commands intended for the peripheral switch can be transmitted via I²C or another serial data protocol, or via a parallel address/data scheme. In this manner, keyboard and mouse control of a computer can be maintained while the peripheral access can be switched. In addition, the keyboard interface 112x and mouse interface 114x could also be switched independently of the peripheral interface 116.

Turning next to FIG. 1B, a block diagram of a system with a universal KVM and USB peripheral switch is illustrated. Like the switch of FIG. 1A, the video switch can be any video switch. Accordingly, only the keyboard, mouse, and peripheral switching capabilities are detailed herein. It will be understood by those skilled in the art that a video data path (not shown) includes a host video interface communicably coupled to the video source and a video interface communicably coupled to a video output device, such as a monitor or the like. Further, it will be understood that the KVM and peripheral switch includes a video switch, communicably coupled to the video data path, configured to switch the video interfaces between the host video interfaces. The video data can be switched either concurrent with, or independent of, the keyboard, mouse, and/or peripheral data through the use of technology known in the art. Any video switching technology known in the art may be used.

The KVM and peripheral switch 100b is generally positioned between and connectable to at least two hosts 101x and at least two sets of user input devices, each set including a keyboard 105x and mouse 107x. The KVM and peripheral switch is also generally positioned between two USB-enabled hosts and at least one USB peripheral. The KVM and peripheral switch 100b may be compatible with USB 1.x, USB 2.x, or both.

The hosts 101x may be any hosts, such as SUN, PS/2, MAC, or USB hosts and are connectable to the switch 100b via a universal host interface 109x, which is configured to accommodate various types of hosts. The keyboard 105x and mouse 107x are connectable to the switch 100b via the universal keyboard and mouse interface 113x, which is configured to accommodate various types of keyboard and mouse devices.

Referring first to the keyboard and mouse data path, each universal host interface 109x is communicably coupled to the computer controller 120x. The computer controller emulates a keyboard and mouse, such as keyboard 105x and mouse 107x, to the universal host interface 109x. Therefore, to the host 101x, the computer controller 120x appears as a keyboard and mouse. The keyboard 105x and mouse 107x are connected to switch 100b via the universal keyboard and mouse interface 113x. The universal keyboard and mouse interface 113x is communicably coupled to the user controller 122x.

Each computer controller 120x is communicably coupled to a bus 123. The bus 123 may be any communication bus, such as an I²C bus or the like. Also coupled to the bus 123 is each user controller 122x. In addition, the computer controller 120x and the user controller 122x may be implemented as a single controller.

As shown, each computer controller 120x interacts with a respective universal host interface 109x. Those skilled in the art will understand that various configurations may be used, such as utilizing a computer controller 120x capable of interacting with multiple universal host interfaces 109x and emulating multiple keyboard and mouse combinations. Similarly, each user controller 122x interacts with a universal keyboard and mouse interface 113x. Those skilled in the art will understand that various configurations may be used, such as utilizing a user controller 122x capable of interacting with multiple universal keyboard and mouse interfaces 113x and emulating a host to each of the universal keyboard and mouse interfaces 113x.

A master controller 124 is also communicably coupled to the bus 123. Thus, the master controller 124 is communicably coupled to the computer controller 120x and to the user controller 122x. Each computer controller 120x, user controller 122x, and the master controller 124 may be a control circuit implemented as one or combinations of the following: programmable circuit, integrated circuit, memory and i/o circuits, an application specific integrated circuit, microcontroller, complex programmable logic device, field programmable gate arrays, other programmable circuits, or the like.

Referring next to the video data path, a monitor(s), display(s) or the like is connectable to the switch 100a via a video interface (not shown). Likewise, a video host is connectable to the switch 100a via a video host interface (not shown). The video data that is switched may include DDC data and may support plug-and-play monitors.

Communicably coupled to the video interface and video host interface is a video switch (not shown), which is in turn communicably coupled to the master controller 124. Thus, the master controller 124 may be configured to control the video switch and the switching of the universal keyboard and mouse interfaces 113x. The video interface may be switched either concurrently with, or independent of, the universal keyboard and mouse interface 113x.

Referring next to the USB peripheral data path, at least one USB peripheral 108x is connectable to the switch 100b via a respective peripheral interface 116x. Communicably coupled to the peripheral interface 116x is a peripheral switch 128. Optionally, a USB hub 134x may be utilized to increase the number of peripheral interfaces 116x connectable to the peripheral switch 128. The peripheral switch 128 may be, for example, a dual analog crosspoint matrix switch, bus switch, router, or any other signal routing mechanism known in the art. The peripheral switch 128 may be a control circuit implemented as one or combinations of the following: programmable circuit, integrated circuit, memory and i/o circuits, an application specific integrated circuit, microcontroller, complex programmable logic device, field programmable gate arrays, other programmable circuits, or the like. Each of the hosts 101x is communicably coupled to the peripheral switch 128 via a respective USB host peripheral interface 118x. The peripheral switch is communicably coupled to the master controller 124, which is communicably coupled to at least one user interface 126x. The user interfaces 126x may be any interface for communicating with the master controller 124, such as one or more of: buttons, LEDs, RS232 commands, Ethernet, one or more remote toggle switch, on-screen display, LCD, and the like.

The computer controller 120x communicates with the host 101x and is configured to receive messages from the host 101x via the universal host interface 109x. The computer controller 120x is further configured to convert these commands to I²C and send the messages to a user controller 122x via the bus 123. The computer controller 120x is configured to receive messages from a user controller 122x via the bus 123, convert the messages from I²C, and send the converted messages to the host 101x via the universal host interface 109x. Because the computer controller 120x is capable of emulation, the computer controller 120x appears to the host 101x as a keyboard, such as a keyboard 105x, and a mouse, such as a mouse 107x.

The user controller 122x communicates directly with the keyboard 105x and the mouse 107x. The user controller 122x is configured to receive messages and commands in the form of I²C data from the computer controller 120x via the bus 123, convert the received data from I²C, and send the converted data to the keyboard 105x and the mouse 107x via the universal keyboard and mouse interface 113x. The user controller 122x is also configured to receive USB data from the keyboard 105x and mouse 107x via the universal keyboard and mouse interface 113x, convert the received data to I²C data, and transmit the converted I²C data to the computer controller 120x via the bus 123. Because the user controller 122x is capable of emulation, the user controller 122x appears to the keyboard 105x and the mouse 107x as a host, such as a host 101x.

The master controller 124 controls switching. The master controller 124 is configured to interpret switching commands received from the appropriate user interface 126x, convert the received commands to I²C data, and communicate to the computer controller 120x and the user controller 122x via the bus 123. The switching commands received from the user interface may contain identification information. Such identification information may include, for example, a user identification number corresponding to the user requesting the switch and a computer identification number corresponding to the computer that the user wishes to connect to.

The user identification information may inform the master controller 124 which user controller 122x to instruct to communicate. Similarly, the computer identification information may inform the master controller 124 which computer controller to instruct to communicate. Thus, based on the computer information and/or user infromation, the master controller 124 may instruct, for example, the computer controller 120a to communicate with the user controller 122c.

The master controller thus communicates via the bus 123, using a communication protocol such as I²C, with the appropriate computer controller 120x and user controller 122x and directs them to communicate data to each other. It will be understood by those skilled in the art that it is possible to have multiple user controllers 122x connected to the same computer controller 120x. In such configurations, the computer controller 120x may implement a “priority receive” and communicate with the first user controller 122x to begin communications-all others will be ignored until a time-out period has passed in which there have been no communications from any of the user controllers 122x.

The master controller 124 may also be configured to implement security features. The master controller 124 may allow and disallow certain user controller 122x and computer controller 120x connections based on permissions. If the master controller 124 receives a request for a connection that is not allowed, the master controller 124 may deny the connection request and respond back to the user interface 126x that the connection cannot be made. Further, connections also may be password and/or biometric data protected. Upon receiving a request for a connection that is password protected, the master controller 124 may request that the appropriate password be entered. Once the correct password has been received and authenticated, the master controller 124 will transmit the commands to the appropriate user controller 122x and computer controller 120x. If authentication fails, the master controller 124 may deny the request or offer another chance to re-enter the correct password.

In addition to switching the universal keyboard and mouse interface 113x among universal host interfaces 109x, it is also possible to switch additional peripheral interfaces 116x among USB host peripheral interface 118x. Additional peripherals 108x may include devices such as printers, scanners, cameras, memories (e.g. disk drives), writing tablets, or any other non-keyboard, non-mouse USB device.

To accomplish the peripheral switching, the USB-enabled host 101x is communicably coupled to a peripheral switch 128, such as dual analog crosspoint matrix switch, via the host peripheral interface 118x. The peripheral switch 128 routes any peripheral USB signals (D+ and D−) to host USB signals. The peripheral switch 128 can connect directly to a USB connector for a USB peripheral, or can connect to another USB hub, such as optional USB hub 134x, allowing multiple USB peripherals to be connected.

The peripheral switch 128 is communicably coupled to the master controller 124. In this configuration, master controller 124 can be configured to permit the peripheral interfaces 116x to be switched independently or concurrently with the universal keyboard and mouse interface 113x. To concurrently switch the peripheral interface 116x with the keyboard interface 112x and mouse interface 114x, the master controller 124 receives switching commands from a user interface 126x and transmits them to both the appropriate computer controller 120x and user controller 122x and to the peripheral switch 128. These commands intended for the peripheral switch can be transmitted via I²C or another serial data protocol, or via a parallel address/data scheme. In this manner, the keyboard 105x, mouse 107x, and any USB devices 108x are switched from one host 101x to another host 101x.

To switch the peripheral interface 116x independently, the master controller 124 receives switching commands from the user interface 126x and determines whether the commands are intended to switch universal keyboard and mouse interfaces 113x, peripheral interfaces 116x, or both. Upon making its determination, the master controller 124 transmits the appropriate commands to the peripheral switch 128. Again, these commands intended for the peripheral switch can be transmitted via I²C or another serial data protocol, or via a parallel address/data scheme. In this manner, keyboard and mouse control of a computer can be maintained while the peripheral access can be switched. In addition, the keyboard interface 112x and mouse interface 114x could also be switched independently of the peripheral interface 116.

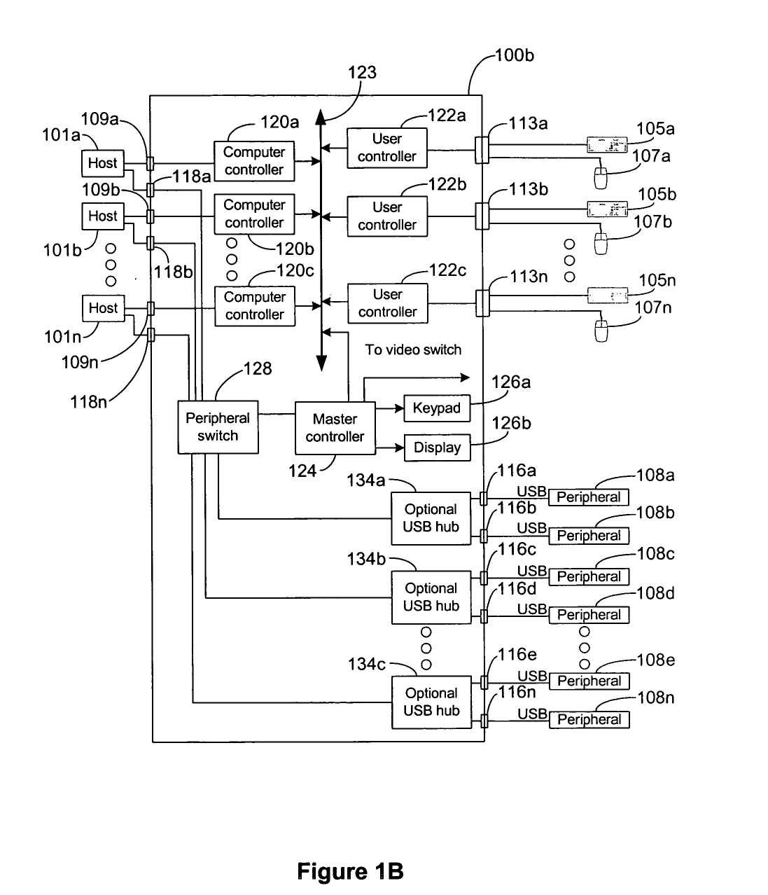

Turning now to FIG. 2 a universal keyboard and mouse interface 113x determines the type of peripheral connected by use of cables 302x with connectors capable of physically connecting to a selected type peripheral. The cables may include internal address jumpers that identify the type of peripheral to the universal keyboard and mouse interface 113x.

For example, a Sun Microsystems keyboard and mouse would plug into a female eight pin mini-DIN connector at one end of the cable 302a and the other end of the cable 302a would plug into a universal keyboard and mouse interface 113x. Generally, four pins are used for the signals, leaving four pins of the peripheral module plug for use as address pins. The address pins are jumpered within the cable assembly in order to provide a unique identity for the type of cable/peripheral to the universal keyboard and mouse interface 113x.

Similarly, an Apple Macintosh keyboard and mouse would plug into a female four pin mini-DIN connector at one end of the cable 302b and the other end of the cable 302b would plug into a universal keyboard and mouse interface 113x. The address pins are added and jumpered within the cable assembly in order to provide a unique identity for the type of cable/peripheral to the universal keyboard and mouse interface 113x.

Similarly, an IBM PS/2 style keyboard and mouse would plug into a pair of female six pin mini-DIN connectors at one end of the cable 302c and the other end of the cable 302c would plug into a universal keyboard and mouse interface 113x. The address pins are jumpered within the cable assembly in order to provide a unique identity for the type of cable/peripheral to the universal keyboard and mouse interface 113x.

Similarly, a USB keyboard and mouse would plug into a female USB connector at one end of the cable 302d and the other end of the cable 302d would plug into a universal keyboard and mouse interface 113x. The address pins are jumpered within the cable assembly in order to provide a unique identity for the type of cable/peripheral to the universal keyboard and mouse interface 113x.

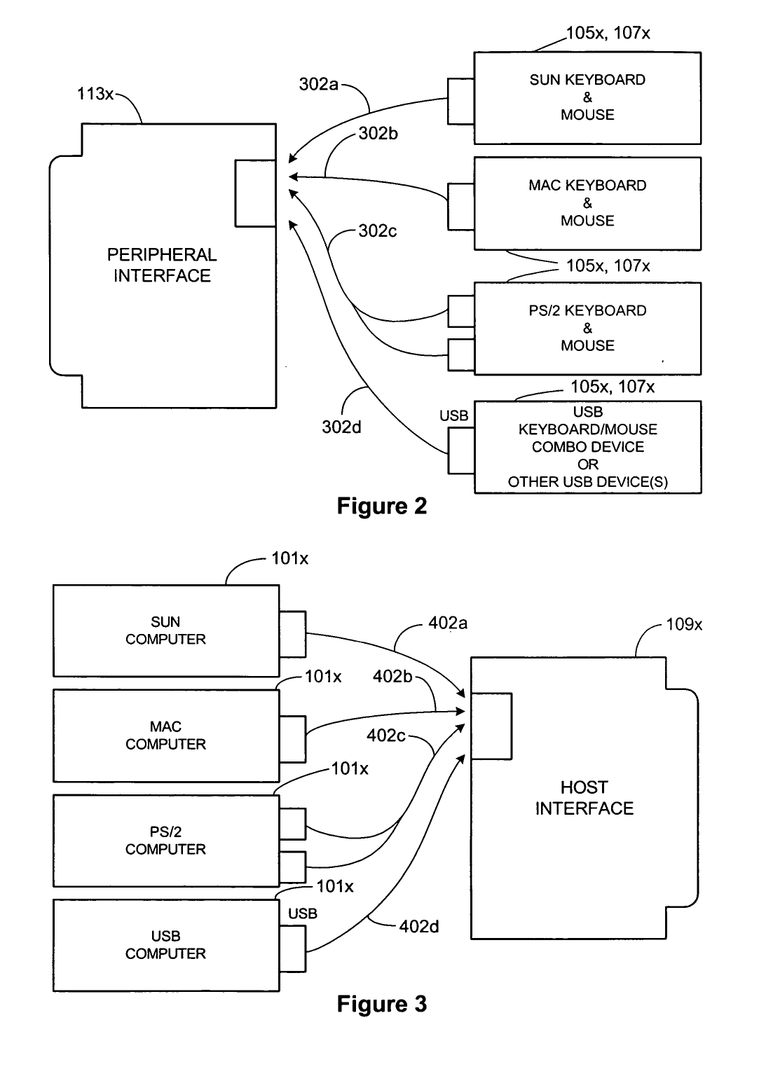

Turning now to FIG. 3 a universal host interface 109x determines the type of peripheral connected by use of cables 402x with connectors capable of physically connecting to a selected type peripheral. The cables preferably include internal address jumpers that identify the type of computer connected to the universal host interface 109x.

For example, a Sun Microsystems computer would accept a male eight pin mini-DIN connector at one end of the cable 402a and the other end of the cable 402a would plug into a universal host interface 109x. The address pins are jumpered within the cable assembly in order to provide a unique identity for the type of cable/peripheral to the universal host interface 109x.

Similarly, an Apple Macintosh computer would accept a male four pin mini-DIN connector at one end of the cable 402b and the other end of the cable 402b would plug into a universal host interface 109x. The address pins are jumpered within the cable assembly in order to provide a unique identity for the type of cable/peripheral to the universal host interface 109x.

Similarly, an IBM PS/2 style computer would accept two male six pin mini-DIN connectors at one end of the cable 402c and the other end of the cable 402c would plug into a universal host interface 109x. The address pins are jumpered within the cable assembly in order to provide a unique identity for the type of cable/peripheral to the universal host interface 109x.

Similarly, a USB computer would accept a male USB connector at one end of the cable 402d and the other end of the cable 402d would plug into a universal host interface 109x. The address pins are jumpered within the cable assembly in order to provide a unique identity for the type of cable/peripheral to the universal host interface 109x.

In operation, a desired keyboard 105x and mouse 107x are connected to the switch 100b by a cable. Based on the cable, the universal keyboard and mouse interface 113x modifies its operation to correspond to the connected keyboard 105x and mouse 107x. In addition, the computer controller 120x may modify its behavior so that the correct type of keyboard 105x and mouse 107x are emulated to the host 101x.

Similarly, when a particular type of host 101x is connected to the switch 100b by a cable, the universal host interface 109x modifies its operation to correspond to the connected host 101x. In addition, the user controller 122x may modify its behavior so that the correct type of host 101x is emulated to the keyboard 105x and mouse 107x.

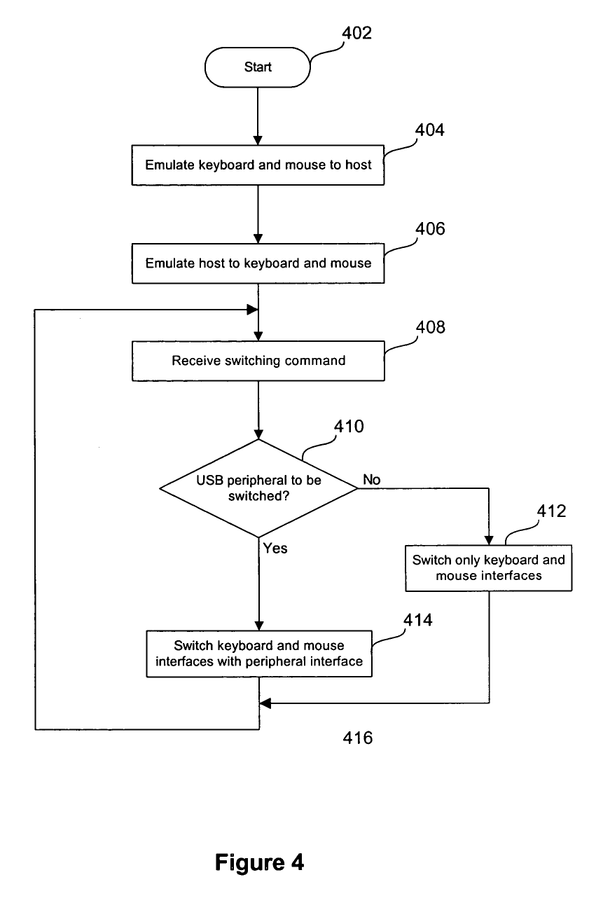

Turning next to FIG. 4, a flow chart generally illustrating an aspect of switching at least one keyboard interface, at least one mouse interface, at least one video interface, and at least one peripheral interface between host interfaces is provided. The basic flow commences at start block 402, from which progress is made to process block 404. At process block 404, a keyboard, such as the keyboard 104x and a mouse, such as the mouse 106x, are emulated to the each of the host interfaces, such as the host interface 110x.

Progression then continues to process block 406 wherein a keyboard and mouse host, such as the host 102x, is emulated to each of the keyboard interfaces, such as the keyboard interface 112x, and each of the mouse interfaces, such as the mouse interface 114x. Where the switch utilizes a universal interface, the host 102x is emulated to the each of the universal interfaces, such as the universal interface 113x shown in FIG. 1B.

Flow then continues to process block 408 wherein a switching command is received at a controller, such as the master controller 124, after which progression continues to decision block 410.

At decision block 410, a determination is made using information from the received switching command as to whether any peripheral interfaces, such as peripheral interface 116x are to be switched concurrently with the keyboard interface and mouse interface, such as the keyboard interface 112x and the mouse interface, such as the mouse interface 114x. In the case where a universal interface is utilized, a determination is made whether any peripheral interfaces, such as peripheral interface 116x, are to be switched concurrently with any universal interfaces, such as universal interface 113x of FIG. 1B.

A negative determination at decision block 410 causes progression to process block 412, wherein a keyboard interface and a mouse interface are switched to a host interface independent of any switching of any of the peripheral interfaces. Also, any of the peripheral interfaces can be switched independently of the keyboard and mouse interfaces.

In addition, the video may be switched either concurrently or independently of the keyboard and mouse interfaces. Progression then flows back to process block 408 to wait for another switching command.

A positive determination at decision block 410 causes progression to process block 414, wherein a keyboard interface and a mouse interface are switched concurrently with a peripheral interface to a host interface. In addition, the video may be switched either concurrently or independently of the keyboard, mouse, and peripheral interfaces. Progression then flows back to process block 408 to wait for another switching command.

While the present invention has been described in association with several exemplary embodiments, the described embodiments are to be considered in all respects as illustrative and not restrictive. Such other features, aspects, variations, modifications, and substitution of equivalents may be made without departing from the spirit and scope of this invention which is intended to be limited solely by the scope of the following claims. Also, it will be appreciated that features and parts illustrated in one embodiment may be used, or may be applicable, in the same or in a similar way in other embodiments.

1. A KVM and peripheral device switch comprising:
a plurality of sets of KVM interfaces, each set of KVM interfaces having a keyboard interface, a mouse interface, and a video interface;
a plurality of sets of host interfaces, each set of host interfaces having a host keyboard and mouse interface and a host video interface;
at least one USB peripheral interface;
at least one host USB peripheral interface; and
a master controller configured to switch at least one of the sets of KVM interfaces and at least one of the USB peripheral interfaces among the host interfaces;
wherein a keyboard and mouse host is emulated to the keyboard interface and the mouse interface; and
wherein a keyboard and a mouse is emulated to the host interface.

2. The KVM and peripheral device switch of claim 1 further comprising:
at least one user controller communicably coupled to the master controller and at least one of the keyboard and mouse interfaces, the user controller being configured to emulate a keyboard and mouse host; and
at least one computer controller communicably coupled to the master controller and at least one of the sets of host keyboard and mouse interfaces, the computer controller being configured to emulate a keyboard and a mouse.

3. The KVM and peripheral device switch of claim 2 wherein the at least one user controller and the at least one computer controller are the same controller.

4. The KVM and peripheral device switch of claim 2 wherein the at least one user controller and the at least one computer controller are communicably coupled.

5. The KVM and peripheral device switch of claim 2 wherein the master controller is configured to select which of the at least one user controllers and which of the at least one computer controllers will communicate with each other.

6. The KVM and peripheral device switch of claim 5 wherein the master controller is configured to direct the selected user controller and the selected computer controller to communicate with each other.

7. The KVM and peripheral device switch of claim 5 wherein the master controller is configured to select user controllers based on received user identification information and computer controllers based on computer identification information.

8. The KVM and peripheral device switch of claim 1 further comprising a video switch communicably coupled to at least one of the video interfaces and at least one of the host video interfaces and configured to switch the video interfaces between the host video interfaces.

9. The KVM and peripheral device switch of claim 8 wherein the video switch is communicably coupled to the master controller.

10. The KVM and peripheral device switch of claim 1 further comprising a switch communicably coupled to the master controller for switching the USB peripheral interfaces between the host peripheral interfaces.

11. The KVM and peripheral device switch of claim 10 wherein the switch is a crosspoint matrix switch.

12. The KVM and peripheral device switch of claim 1 wherein the KVM and peripheral switch is compatible with both USB 1.x and USB 2.x.

13. The KVM and peripheral device switch of claim 1 wherein the KVM and peripheral device switch is capable of concurrently and independently switching keyboard and mouse interfaces between keyboard and mouse host interfaces and peripheral interfaces between host peripheral interfaces.

14. The KVM and peripheral device switch of claim 1 wherein the keyboard interface and mouse interface are each selected from the group consisting of: SUN, PS/2, MAC, USB, Universal, and combinations thereof.

15. The KVM and peripheral device switch of claim 1 further comprising a user interface selected from the group consisting of: buttons, RS232 commands, Ethernet, remote toggle switch, on-screen display, and combinations thereof.

16. A KVM and peripheral device switch comprising:
a plurality of sets of KVM interfaces, each set of KVM interfaces having a keyboard interface, a mouse interface, and a video interface;
at least one user controller communicably coupled to at least one of the sets of KVM interfaces, the user controller being configured to emulate a keyboard and mouse host; and
a plurality of sets of host interfaces, each set of host interfaces having a host keyboard and mouse interface and a host video interface;
at least one computer controller communicably coupled to at least one of the sets of host interfaces, the computer controller being configured to emulate a keyboard and a mouse;
at least one USB peripheral interface;
at least one host USB peripheral interface; and
a peripheral switch communicably coupled to at least one of the peripheral interfaces and to at least one of the host peripheral interfaces and configured to switch the USB peripheral interfaces between the host peripheral interfaces; and
a video switch communicably coupled to at least one video interface and to at least one host video interface and configured to switch the video interfaces between the host video interfaces; and
a master controller communicably coupled to the user controller, the computer controller, the peripheral switch, and the video switch and configured to switch at least one of the sets of keyboard, mouse and video interfaces and at least one of the USB peripheral interfaces between the host peripheral interfaces.

17. The KVM and peripheral device switch of claim 16 wherein the master controller is configured to direct the selected user controller and the selected computer controller to communicate with each other.

18. The KVM and peripheral device switch of claim 16 wherein the KVM and peripheral switch is compatible with both USB 1.x and USB 2.x.

19. The KVM and peripheral device switch of claim 16 wherein the KVM and peripheral switch is capable of concurrently and independently switching keyboard and mouse interfaces between keyboard and mouse host interfaces and peripheral interfaces between host peripheral interfaces.

20. The KVM and peripheral device switch of claim 16 wherein the keyboard interface and mouse interface are each selected from the group consisting of: SUN, PS/2, MAC, USB, Universal, and combinations thereof.

21. A method for switching at least one keyboard interface, at least one mouse interface, at least one video interface, and at least one USB peripheral interface between host interfaces comprising:
emulating a keyboard and a mouse to each host interface;
emulating a host to each keyboard interface and mouse interface;
receiving a switching command at a controller, the switching command containing identification information; and
using the identification information to connect at least one of the keyboard interfaces, at least one of the mouse interfaces, at least one of the video interfaces, and at least one of the peripheral interfaces to at least one of the host interfaces.

22. The method of claim 21, further comprising:
(a) determining whether the peripheral interface is to be switched concurrently with the keyboard interface and the mouse interface;
(b) concurrently switching the peripheral interface with the keyboard interface and mouse interface upon a positive determination in step (a).
